(19) United States
(12) Patent Application Publication
(10) Pub. No.: US 2003/0070854 A1
(43) Pub. Date: Apr. 17, 2003

(54) Cooling extrusion for a straddle-mounted vehicle

(75) Inventor: Ron Bergman, McIntosh, MN (US)

Correspondence Address: MERCHANT & GOULD PC, P.O. BOX 2903, MINNEAPOLIS, MN, 55402-0903, US

(73) Assignee: ARCTIC CAT INC.

(21) Appl. No.: 09/981,465

(22) Filed: Oct. 16, 2001

(51) Int. Cl. B60K 11/00; B62M 27/02

(52) U.S. Cl. 180/182; 180/68.1

(57) ABSTRACT

A cooling extrusion for a vehicle such as a snowmobile having a liquid-cooled engine includes an elongate tube made from a single piece of material having at least one end comprising an integrally formed fitting. The elongate tube also may include at least one integrally formed bend. The bend may be located in close proximity to an end of the elongate tube. The cooling extrusion may be secured to a running board of a snowmobile.

### FIELD OF THE INVENTION

This invention relates to a cooling extrusion for a straddle-mounted vehicle and; more particularly, the invention relates to a cooling extrusion for a snowmobile made from a single piece of material and having at least one end including an integrally formed fitting.

### BACKGROUND

Snowmobiles are a widely used means of transportation in snowy regions. They are especially popular for recreational purposes such as trail riding or racing. Liquid-cooled engine powered snowmobiles are widely known and very popular.

In a typical liquid-cooled engine for a snowmobile, the hoses, cooling extrusions running along the length of the vehicle, heat exchanger, and engine together form a cooling circuit. In general, hot liquid from the engine is pumped through the cooling extrusions to the heat exchanger located at the rear of the vehicle. The cooling extrusion is connected to the heat exchanger via a hose. Cooled liquid from the heat exchanger the flows through another cooling extrusion returning to the engine block. The cooled liquid is then circulated through the engine block to keep it from overheating. Due to the low temperature operating environment for snowmobiles, the cooling liquid usually includes an appropriate mixture of water and antifreeze.

### SUMMARY

In an embodiment of the present invention, a cooling extrusion for a snowmobile includes an elongate tube made from a single piece of material and having a first end and a second end, wherein at least one end has an integrally formed fitting. By “integrally formed” it is meant that the fitting and the elongate tube are formed as a single structure or unit from the same piece of material.

In another embodiment of the present invention, the elongate tube further includes at least one integrally formed bend.

In yet another embodiment of the present invention, a snowmobile includes: a chassis; an endless drive track; a pair of forwardly mounted steerable skis; an engine including a pump; a heat exchanger; a running board; and at least one cooling extrusion. The cooling extrusion is an elongate tube made from a single piece of metal having a first end and a second end with at least one end having an integrally formed fitting. Additionally, the elongate tube may also include at least one integrally formed bend. The cooling extrusion may be secured to or form a part of the running board of the snowmobile.

A variety of additional advantages of the invention will be set forth in the description which follows, and will be apparent from the description. It is to be understood that both the foregoing material and the following detailed description are exemplary and explanatory only, and are not restrictive of the invention as claimed.

### BRIEF DESCRIPTION OF THE DRAWINGS

The accompanying drawings, which are incorporated in and constitute a part of this specification, illustrate several aspects of the invention and together with the description, serve to explain the principles of the invention. A brief description of the drawings is as follows:

FIG. 1A shows a plan view of a cooling extrusion according to the present invention.

FIG. 1B shows a side view of a cooling extrusion according to the present invention.

FIG. 1C shows a cross-sectional view of the cooling extrusion of FIG. 1B along the line A-A.

FIG. 2 is a side-view of a cooling extrusion according to the present invention.

FIG. 3A is a side view of an end of a cooling extrusion according to the present invention.

FIG. 3B is an expanded view of a hose communicating with the end of a cooling extrusion shown in FIG. 3A.

FIG. 4 is an end view of a cooling extrusion according to the present invention.

FIG. 5A is a plan view of a snowmobile.

FIG. 5B is a side view of a snowmobile.

FIG. 6 is an schematic partial view of a snowmobile.

### DETAILED DESCRIPTION

Reference will now be made in detail to exemplary aspects of the present invention that are illustrated in the accompanying drawings. The same reference numbers will be used throughout the drawings to refer to the same or like parts. It should be noted that throughout the description, the terms “including” and “having” are used synonymously with “comprising”.

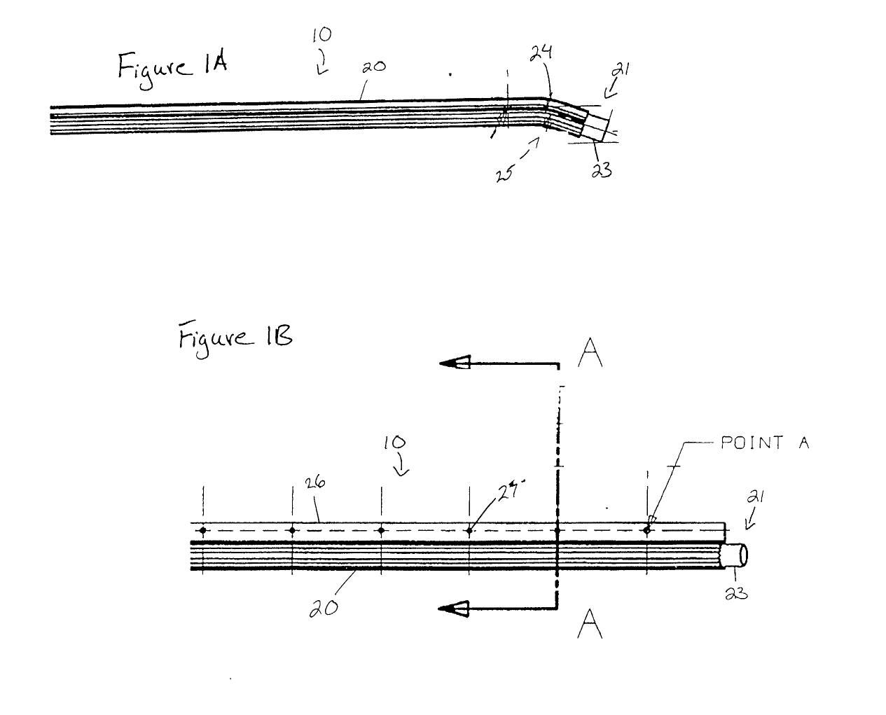

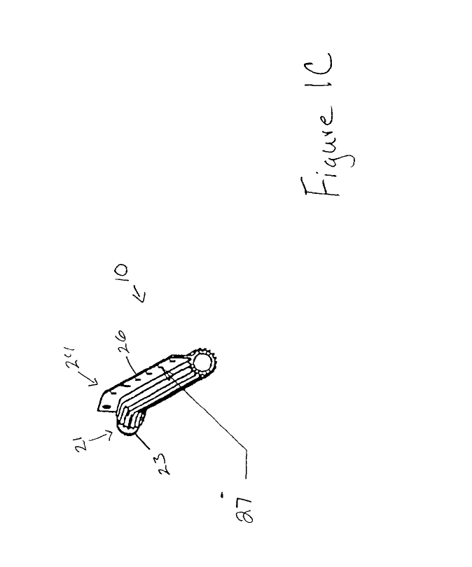

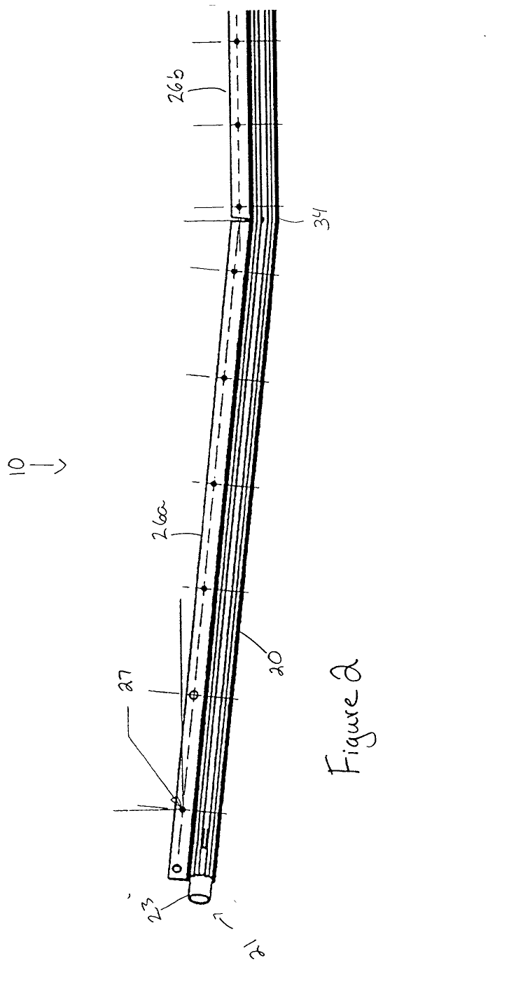

FIG. 1A shows a plan view of a cooling extrusion 10 according to an embodiment of the present invention. The cooling extrusion 10 includes an elongate tube 20 having a first end 21 and a second end 22 (not shown) with a hollow bore extending between there. The elongate tube 10 is capable of transporting cooling liquid from one point to another on a vehicle. The cooling liquid may be an appropriate mixture of water and antifreeze.

The elongate tube 10 is formed from a single piece of material. Preferably, an extrusion process is used to manufacture the elongate tube 10. The material from which the elongate tube 10 is made is preferably a heat-transfer material that is capable of undergoing a rapid heat-exchange with a surrounding environment. Generally, the material is selected from metals and lightweight alloys. In a preferred embodiment, the material is extruded aluminum.

FIGS. 1A and 1B depict an end 21 including an integrally formed fitting 23. By “integrally formed” it is meant that the fitting 23 and the elongate tube 20 are formed as a single structure or unit from the same piece of material. In other words, a separate piece is not required to be fitted onto the tube 20 in order for the fitting to be formed in the tube 20. Possible fittings include, but are not limited to, the following: barb (spud), flare, push-to-connect, and ferruless compression fittings. Preferably, the fitting 23 is a barb fitting. If both ends of the elongate tube 20 include integrally formed fittings, the fittings at either ends of the tube are not required to be of the same type. The fitting 23 may be machined, pressed, or crimped into an end of the elongate tube 20. Preferably, the fitting 23 is machined.

The elongate tube 20 may include a bend 24 located in close proximity to an end 21 of the elongate tube, as shown in FIG. 1A. Preferably, the bend 24 is located in close proximity to the end 21 of the tube 20 having an integrally formed fitting 23. The bend 24 also is integrally formed in the elongate tube 20. For the purposes of this application, “integrally formed” is intended to mean that the bend 24 is formed as a single structure with the elongate tube 20 from the same piece of material. A separate element is not required in order to form the bend 24. Close proximity can be considered as being located at a point that is within approximately 20% of the end of the tube. Preferably, the bend 24 is located within 5 to 10% of the end 21 of the elongate tube 20. Within is defined as meaning equal to or less than, and approximately allows for a deviation of 10% in measuring the length of the tube. The angle 25 at which the bend 24 is formed sufficiently allows the end of the extrusion to communicate with a heat exchanger or engine block located on the vehicle. Typically, the cooling extrusion 10 communicates with the heat exchanger or engine block via a hose.

Providing the cooling extrusion 10 including an elongate tube 20 having an integrally formed fitting 23 eliminates the needs for additional pieces to be fixed to the tube in order to form the fitting 23. This simplifies the manufacturing process and reduces the overall manufacturing cost. An integrally formed fitting also minimizes failure and corrosion due to leakage of the fluid by eliminating the juncture at the fitting and the elongate tube. Additionally, because the tube and the fitting are made from the same piece of the material, the tube will have uniform properties throughout the length of the tube. This eliminates failure and stress due to differences in expansion coefficients and heat transfer coefficients of different elements that otherwise would be used to manufacture a typical cooling extrusion.

Providing the elongate tube 20 with an integrally formed bend 24 allows for a greater flexibility in the snowmobile design. A bend 24 may be formed at any location along the tube 20 allowing for greater flexibility in the placement of the cooling extrusion. Preferably, the bend 20 is located in close proximity to the end having the integrally machined fitting such that a hose from a heat exchanger or engine block easily could be connected to the cooling extrusion. Additionally, providing an integrally formed bend 24 in the elongate tube 20 eliminates steps in the manufacturing process that otherwise would be required, thus, simplifying and reducing the cost of the manufacturing process.

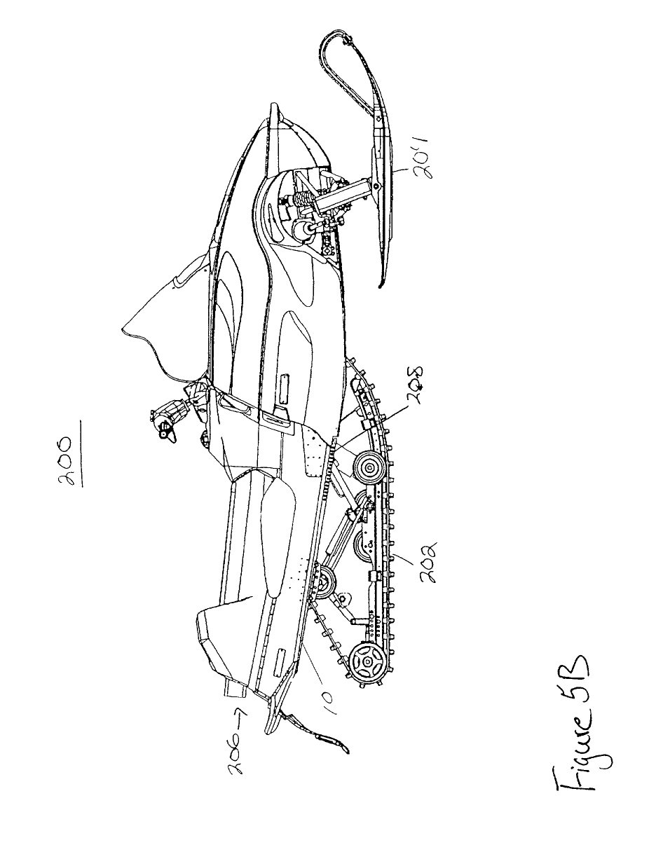

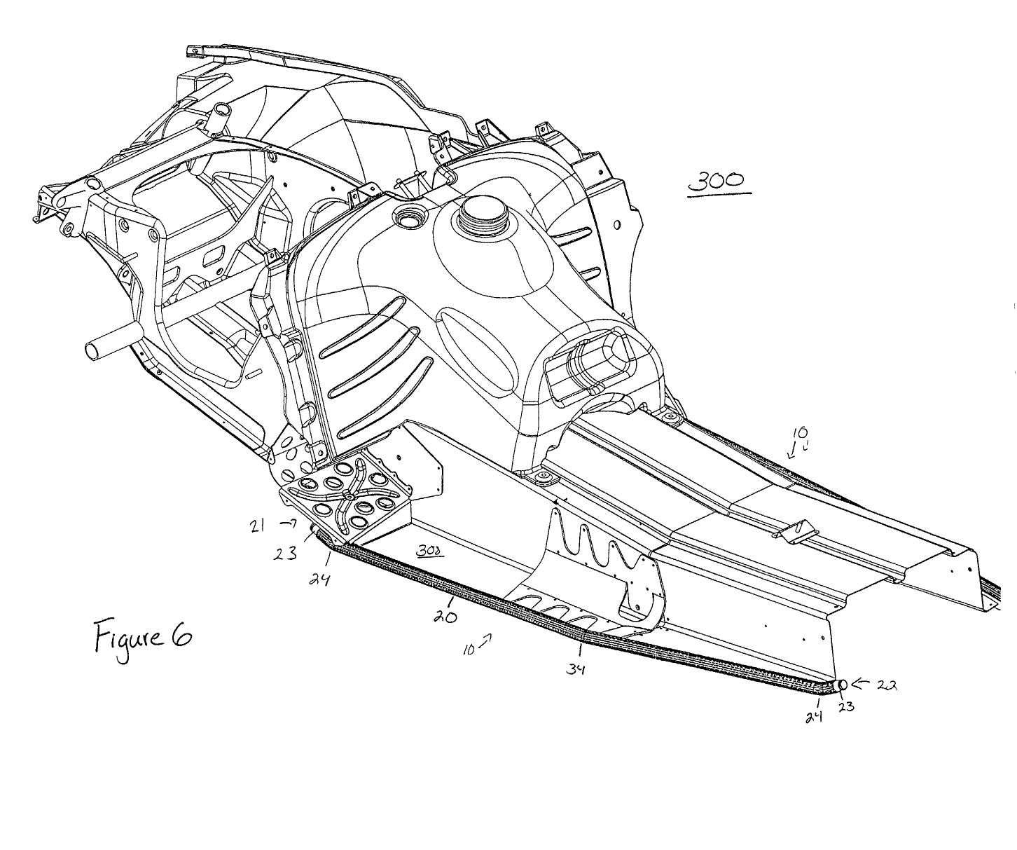

FIG. 1B is a side view of the cooling extrusion 10 depicted in FIG. 1A. FIG. 1C is an end view of the cooling extrusion 10. FIG. 1B shows a mounting flange 26 provided along a longitudinal length of the elongate tube 20. The mounting flange 26 may be integrally formed with the elongate tube 20 and follows the length of the tube 20 (best shown in FIG. 1C). By “integrally formed” it is meant that the mounting flange 26 and the elongate tube 20 are formed as a single structure or unit from the same piece of material. The mounting flange 26 may comprise a plurality of apertures 27 for accommodating a variety of fasteners, and is used to secure the cooling extrusion 10 to the vehicle at a desired location. Preferably, the cooling extrusion 10 is mounted and secured to the running board of a snowmobile (shown in FIGS. 5A and 5B). It should be appreciated that the flexibility in the design due to the integrally formed fitting 23 and integrally formed bend 24 allows for placement of the cooling extrusion 10 at other locations on the vehicle.

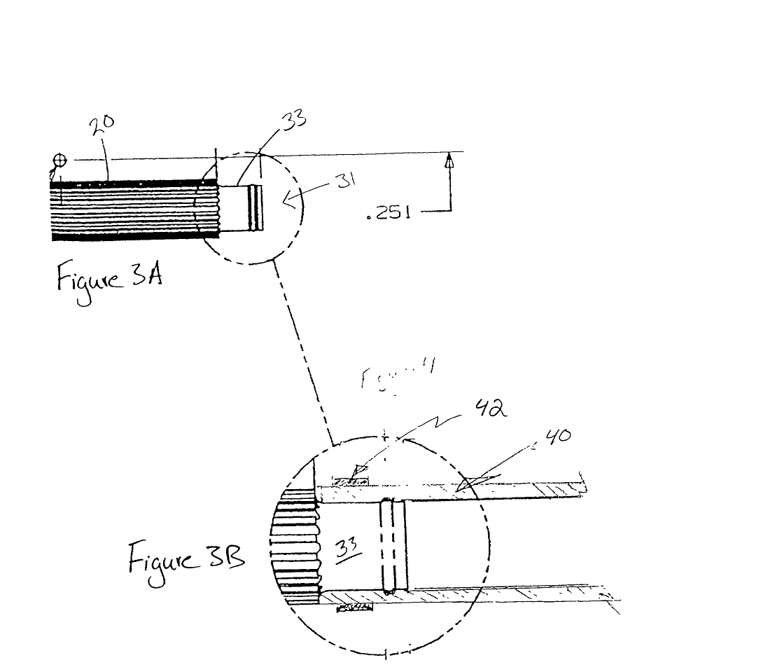

FIG. 2 is a side view of a cooling extrusion 10 according to an embodiment of the present invention. As shown in FIG. 2, a bend 34 may be located distal from a first end 21 of the elongate tube 20. In order to accommodate the bend 34 in the tube 20 being so far from the first end 21 of the tube 20, the flange 26 is divided into a first portion 26a and a second portion 26b. It should be appreciated that the mounting flange 26 may be divided into additional sections as necessary. The mounting flange 26 need not be divided when the integrally formed bend 34 is provided in close proximity to an end of the tube due to the lack of strain placed on the mounting flange, as shown in FIGS. 1A and 1C.

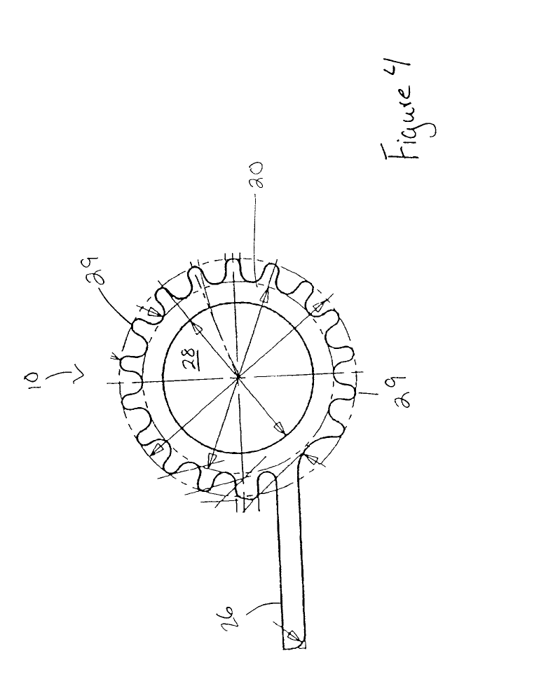

FIG. 3A illustrates one type of fitting 33 that may be integrally formed at one end 31 of the elongate tube 20. FIG. 3B is an expanded view of the fitting 33 depicted in FIG. 3A, and depicts the integrally formed fitting 33 communicating with a hose 40. Possible choices for the fitting 33 include, but are not limited to, the following: barb (spud), flare fittings, push-to-connect, and ferruless compression fittings. The fitting 33 may be machined, pressed, or crimped into one or both ends of the elongate tube. If both ends 31 of the elongate tube 20 include integrally formed fittings 33, the fittings 33 at either ends of the tube 20 are not required to be of the same type. Preferably, the fitting 33 is a barb fitting, as shown in FIGS. 3A and 3B.

FIG. 3B shows a hose 40 communicating with the integrally formed barb fitting 33 at one end of an elongate tube. The hose 40 is placed over the fitting 33 and may be secured with a clamp 42. It shall be appreciated that any type of clamp 42 for removeably securing a hose 40 to a fitting 33 is suitable.

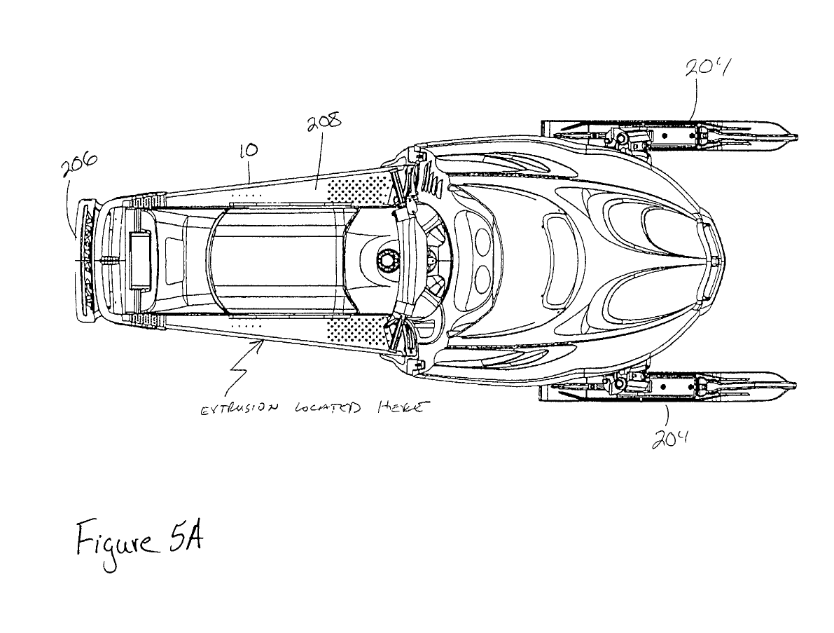

FIG. 4 shows a cross-sectional end view of the cooling extrusion 10 according to the present invention. An interior of the hollow bore 28 of the elongate tube 20 is depicted as having a circular cross-section. Any cross-sectional shape is suitable so long as it allows for sufficient passage of cooling liquid. A plurality of heat-exchanging fins 29 may be provided on an outer surface of the elongate tube 20. The fins 29 may be integrally formed along a longitudinal length of the elongate tube 20, and provide a greater surface area over which the heat from the cooling liquid is dissipated from the tube 20. By “integrally formed” it is meant that the fins 29 and the elongate tube 20 are formed as a single structure or unit from the same piece of material. The heat-exchanging fins 29 may be equal in height to one another when measured from an inner circumference of the elongate tube. Additionally, the height of the valleys formed between the fins 29 may be equal to one another when measured from a center point of the hollow bore 28. An end of the mounting flange 26 is also visible in FIG. 4.

FIGS. 5A and 5B depict different views of a snowmobile 200 having a cooling extrusion 10 according to an embodiment of the present invention. Typically, a snowmobile 200 includes, but is not limited to: a chassis (not visible); an endless drive track 202; a pair of forwardly mounted steerable skis 204; an engine including a pump (not shown); a heat exchanger 206; a running board 208; and at least one cooling extrusion 10. The cooling extrusion 10 is an elongate tube made from a single piece of metal having a first end and a second end with at least one end having an integrally formed fitting. Additionally, the elongate tube may also include at least one integrally formed bend 24 (visible in FIG. 6). The cooling extrusion 10 may be secured to the running board 208, 308 of the snowmobile 200 as shown in FIGS. 5A, 5B, and FIG. 6.

FIG. 6 is a partial schematic view of a snowmobile 300 according to an embodiment of the present invention. As shown in FIG. 6, two cooling extrusions 10 may be secured to the running boards 308 located on either side of the snowmobile 300. The cooling extrusions 10 may include first and second ends 21, 22 each having an integrally formed fitting 23. Additionally, the cooling extrusions 10 also may include two integrally formed bends 24 located in close proximity to the first and second ends 21, 22, respectively. For the purposes of this application, close proximity is defined as being located at a point that is within approximately 20% of the end 21, 22 of an elongate tube 20. Preferably, the bends 24 are located within 5 to 10% of the ends 21, 23 of the elongate tube 20. Within is defined as meaning equal to or less than, and approximately allows for a deviation of 10% in measuring the length of the tube 20. The angles 25 at which the bends 24 may be formed so as to allow the cooling extrusion 10 to communicate with a heat exchanger or engine block located on the vehicle via a hose (not shown). Additionally, FIG. 6 shows that the cooling extrusions 10 may also include an additional bend 34 located distal from an end 21 of the tube 20.

The above specification, examples and data provide a description of the manufacture and use of the composition of the invention. However, the present invention is not limited thereto. Since many embodiments of the invention can be made without departing from the spirit and scope of the invention, the invention is defined in the claims hereinafter appended.

We claim:

1. A cooling extrusion for a snowmobile comprises an elongate tube comprising a first end and a second end, wherein the elongate tube is made from a single piece of metal and has at least one end that comprises a integrally formed fitting.

2. A cooling extrusion according to claim 1, wherein the elongate tube further comprises at least one integrally formed bend.

3. A cooling extrusion according to claim 1, wherein the elongate tube further comprises at least one integrally formed bend located in close proximity to an end of the tube.

4. A cooling extrusion according to claim 1, wherein the fitting is a barb fitting.

5. A cooling extrusion according to claim 1, wherein the elongate tube further comprises a mounting flange.

6. A cooling extrusion according to claim 6, wherein the mounting flange extends along a longitudinal length of the elongate tube.

7. A cooling extrusion according to claim 5, wherein the mounting flange has a first portion and a second portion.

8. A cooling extrusion according to claim 1, wherein the elongate tube further comprises a plurality of integrally formed fins extending along a longitudinal length of the elongate tube.

9. A snowmobile including a chassis, an endless drive track, a pair of forwardly mounted steerable skis, an engine including a pump, a heat exchanger, and a running board comprises at least one cooling extrusion, the cooling extrusion comprising an elongate tube having a first end and a second end, wherein the elongate tube is made from a single piece of material and has at least one end that comprises a integrally formed fitting.

10. A snowmobile according to claim 9, wherein the elongate tube further comprises at least one integrally formed bend.

11. A snowmobile according to claim 9, wherein the cooling extrusion is secured to the running board.
